(19) United States
(12) Patent Application Publication
(10) Pub. No.: US 2026/0156092 A1
(43) Pub. Date: Jun. 4, 2026

(54) METHODS AND SYSTEMS FOR GENERATING OPTIMIZED COMMUNICATION(S) IN A DIGITAL COMMUNICATION NETWORK

(71) Applicant: Sequelae, Inc., Minneapolis, MN (US)

(72) Inventors: Salomea Anna Jankovic, Minneapolis, MN (US); James LaBelle, Encinitas, CA (US); Benjamin C. Wiegand, Yardley, PA (US); Steven J. Catani, Athens, GA (US)

(73) Assignee: Sequelae, Inc., Minneapolis, MN (US)

(21) Appl. No.: 19/406,220

(22) Filed: Dec. 2, 2025

Related U.S. Application Data
(60) Provisional application No. 63/726,976, filed on Dec. 2, 2024.

(51) Int. Cl. H04L 51/063

(52) U.S. Cl. CPC H04L 51/063

(57) ABSTRACT

Methods and systems for generating optimized communications are provided. A digital communication network (DCN) is provided for a plurality of members of a population to communicate with each other. An initial communication is received from an individual member on the DCN. An optimized communication is generated based on optimizing the initial communication for one or more other members of the population while maintaining the same communication meaning as the initial communication. The optimized communication is then transmitted to the one or more other members.

### CROSS REFERENCE TO RELATED APPLICATIONS

This application claims the benefit of U.S. Provisional Application No. 63/726,976, filed on Dec. 2, 2024, which application is incorporated herein by reference in its entirety.

### BACKGROUND

Various embodiments relate generally to methods and systems for generating optimized communications and in particular, for generating optimized communications in a digital communication network (DCN).

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Digital communication networks, which can include social media where individuals can interact with others online, connect many with a community. For example, a digital communication network can be used to connect members using the same health insurance or health care. However, as members interact with each other, a first member may ignore or discount a second member's experience or information if the first member perceives the second member as unrelatable. For example, a citizen of one age group may ignore information from a citizen of another age group due to the belief that citizens of different age groups have vastly different experiences. In such examples, the second member's experience or information may be relevant and helpful to the first member.

Thus, what is needed is a way to “translate” or convert communications between members into optimized communications in the digital communications network.

### SUMMARY

Example aspects of the present disclosure include:

A method for generating an optimized communication according to at least one embodiment of the present disclosure comprises providing a digital communication network (DCN) for a plurality of members of a population to communicate with each other; identifying an individual member of the plurality of members; receiving an initial communication from the individual member on the DCN, the initial communication having a first set of words; generating an optimized communication based on the initial communication, the optimized communication having a second set of words, wherein at least one word of the second set of words is different from the first set of words, wherein the second set of words are optimized for one or more other members of the plurality of members, and wherein the second set of words has a second communication meaning that is the same as a first communication meaning of the first set of words; transmitting the optimized communication to the one or more other members of the plurality of members.

Any of the aspects herein, wherein generating the optimized communication includes prompting a large language model with the initial communication, information about the one or more other members, and instructions to optimize the initial communication for the one or more members while keeping the same communication meaning.

Any of the aspects herein, wherein the language model optimizes the initial communications by performing the operations of: analyzing the first set of words for the communication meaning; and determining the second set of words based on the communication meaning and the information about the one or more other members.

Any of the aspects herein, wherein the information about the one or more other members includes a communication style of the one or more other members.

Any of the aspects herein, wherein the communication style is based on one or more of a demographic of the one or more other members, an education level of the one or more other members, a culture of the one or more other members, a region of the one or more other members, a specific training of the one or more other members, or employment of the one or more other members.

Any of the aspects herein, wherein the second set of words is further optimized to at least one or more of promote a positive behavior change in the one or more other members, increase happiness in the one or more other members, improve a mood in the one or more other members, or reduce anxiety in the one or more other members.

Any of the aspects herein, wherein the second set of words is further optimized to slow a progression of an adverse health condition in the one or more other members.

Any of the aspects herein, wherein the adverse condition is determined by automatically analyzing communications from the one or more other members.

Any of the aspects herein, wherein the adverse health condition comprises at least one of chronic systemic inflammation, malaise, low energy, a disease, a health risk, social dysfunction, or a prodromal disease.

Any of the aspects herein, wherein the disease comprises at least one of obesity, diabetes, rheumatoid arthritis, Crohn's disease, psoriasis, eczema, cardiovascular disease, congestive heart failure, chronic obstructive pulmonary disease, asthma, depression, or anxiety.

Any of the aspects herein, wherein the health risk is at least one of falling or becoming infected with an illness.

A system for generating an optimized communication according to at least one embodiment of the present disclosure comprises a computer processor; a data repository in communication with the computer processor and storing: an initial communication having a first set of words and a first communication meaning, and an optimized communication having a second set of words and a second communication meaning; a digital communications network (DCN) which, when executed by the computer processor, provides a network for a plurality of members of a population to interact with at least each other or the DCN; and a server controller which, when executed by the computer processor: receives the initial communication from the individual member; generates an optimized communication based on the initial communication; transmits the optimized communication to one or more other members of the plurality of members, wherein at least one word of the second set of words is different from the first set of words, wherein the second set of words are optimized for one or more other members of the plurality of members, and wherein the second set of words has a second communication meaning that is the same as a first communication meaning of the first set of words.

Any of the aspects herein, wherein generating the optimized communication includes prompting a large language model with the initial communication, information about the one or more other members, and instructions to optimize the initial communication for the one or more members while keeping the same communication meaning.

Any of the aspects herein, wherein the language model optimizes the initial communications by performing the operations of: analyzing the first set of words for the communication meaning; and determining the second set of words based on the communication meaning and the information about the one or more other members.

Any of the aspects herein, wherein the information about the one or more other members includes a communication style of the one or more other members.

Any of the aspects herein, wherein the communication style is based on one or more of a demographic of the one or more other members, an education level of the one or more other members, a culture of the one or more other members, a region of the one or more other members, a specific training of the one or more other members, or employment of the one or more other members.

Any of the aspects herein, wherein the second set of words is further optimized to at least one or more of promote a positive behavior change in the one or more other members, increase happiness in the one or more other members, improve a mood in the one or more other members, or reduce anxiety in the one or more other members.

Any of the aspects herein, wherein the second set of words is further optimized to slow a progression of an adverse health condition in the one or more other members.

Any of the aspects herein, wherein the adverse condition is determined by automatically analyzing communications from the one or more other members.

Any of the aspects herein, wherein the adverse health condition comprises at least one of chronic systemic inflammation, malaise, low energy, a disease, a health risk, social dysfunction, or a prodromal disease.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

Aspects of the described embodiments are more evident in the following description, when read in conjunction with the attached Figures.

FIG. 1 shows a simplified block diagram of devices, in accordance with one or more embodiments.

FIG. 2 is a logic flow diagram that illustrates the operation of a method, in accordance with one or more embodiments.

FIG. 3 is a logic flow diagram that illustrates the operation of a method, in accordance with one or more embodiments.

FIG. 4A shows an example of a computing system, in accordance with one or more embodiments.

FIG. 4B shows an example of a network, in accordance with one or more embodiments.

### DETAILED DESCRIPTION

As previously described, a digital communication network can be used to connect members of a population or community. However, as members interact with each other, a first member may ignore or discount a second member's experience or information if the first member perceives the second member as unrelatable. In such examples, the second member's experience or information may be relevant and helpful to the first member and thus it is desirable for the first member to be receptive to the second member's experience for information.

Thus, methods and systems to overcome a set of members ignoring or not trusting communications from another member due to communication styles are provided. Generally, the methods and systems include receiving an initial communication from an individual member of the DCN and generating an optimized communication based on the initial communication. In some embodiments, the optimized communication is generated automatically by a large language model.

Generating the optimized communication includes optimizing the initial communication based on information from one or more other members while maintaining the same communication meaning as the initial communication. The information from the one or more other members may include, for example, a communication style of the one or more other members.

The initial communication may be optimized to achieving a positive behavior change in the other members or achieving happiness, improved mood, reduced anxiety, in the other members. The optimization may also be based on analyzing the other members communications in the DCN. Such analysis of communications can also be used to determine the communication style. The communication style can be associated with a demographic, an education level, a culture, a region, a specific training, employment, etc.

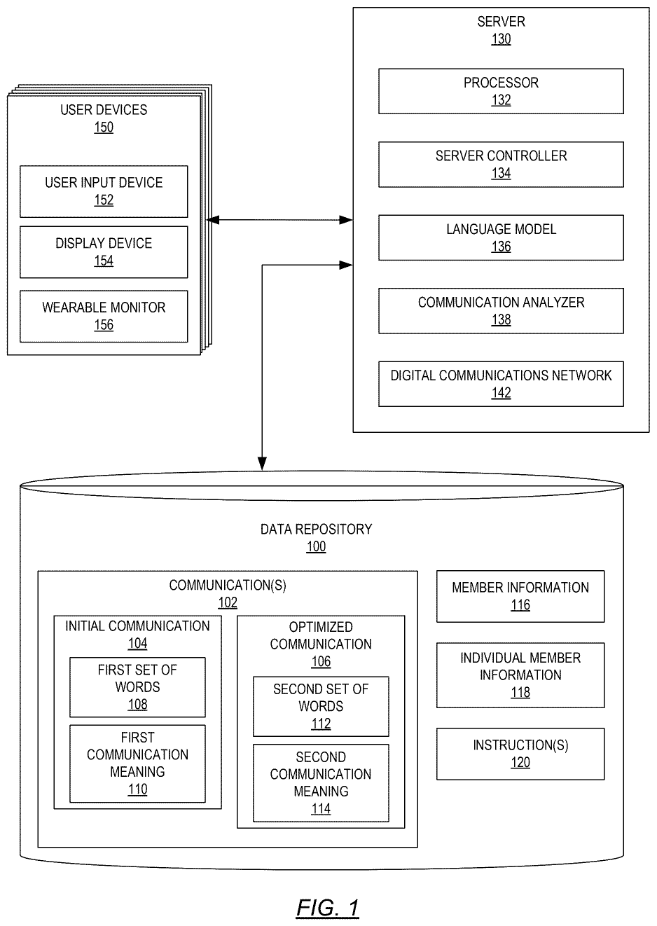

The system shown in FIG. 1 includes a data repository (100). The data repository (100) is a type of storage unit or device (e.g., a file system, database, data structure, or any other storage mechanism) for storing data (described below). The data repository (100) may include multiple different, potentially heterogeneous, storage units and/or devices.

The data repository (100) stores communications (102). The communications (102) are communications from members in a digital communication network (DCN) (142) (described in more detail below). The communications (102) may be, for example, text-based, image-based, multimedia communications, audio communications, or any combinations thereof. The communications may be between members, communications in a forum, communications with the DCN (142), or communications generated by the DCN (142) (e.g., communications from a conversation bot, also referred to as a chat bot). The communications (102) may include, for example, a post and/or a post title that the individual member created in the DCN (142).

The communications (102) can also include an initial communication (104) and an optimized communication (106). The initial communication (104) is a communication from an individual member and the optimized communication (106) is the initial communication (104) optimized for one or more other members of the DCN (142).

The initial communication (104) includes a first set of words (108) and a first communication meaning (110). The initial communication (104) can include other media such as images, video, and/or audio.

The optimized communication (106) includes a second set of words (112) and a second communication meaning (114). The optimized communication (106) can also include other media such as images, video, and/or audio. At least some of the second set of words (112) are different than the first set of words (108) and are optimized for one or more other members of the DNC (142).

The second communication meaning (114) is the same as the first communication meaning (110) such that the optimized communication (106) has the same communication meaning as the initial communication (104) but expressed in different words and/or media optimized for the one or more other members of the DCN (142). In other words, the optimized communication (106) does not change the meaning of the initial communication (104) and is optimized for the one or more other members. For example, the initial communication (104) may include terms or phrases used by members of a first age range that the individual member belongs to, and the optimized communication (106) may remove those terms or phrases. In another example, the terms or phrases used by members of the first age range may be replaced with the equivalent terms or phrases used by members of a second age range that the one or more other members belongs to. By converting or optimizing the initial communication (104) into the optimized communication (106), the optimized communication (106) may be more favorably received by the one or more other members.

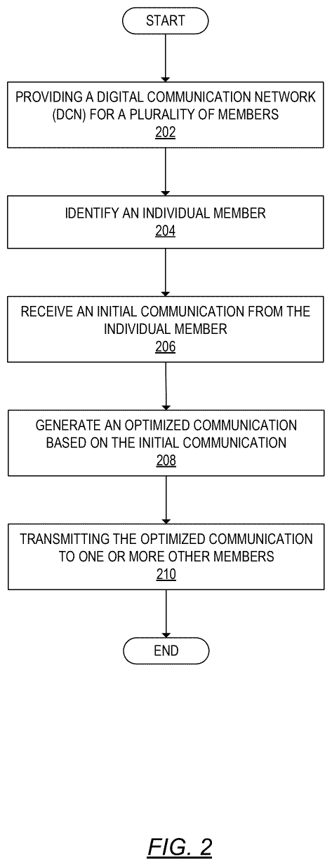

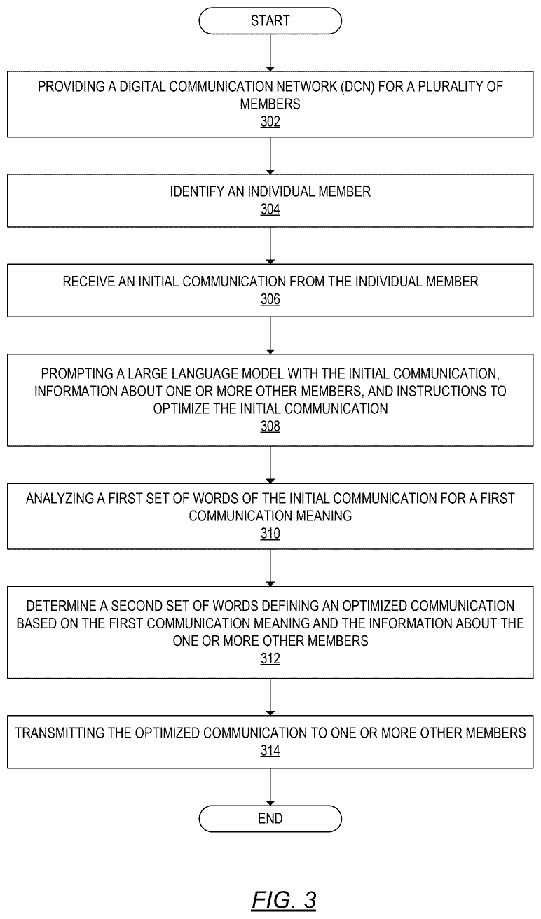

Generating the optimized communication (106) will be described in detail in FIGS. 2 and 3.

The data repository (100) also stores member information (116). The member information (116) includes, for example, a communication style of the one or more other members. The member information (116) can also include information about the one or more other members such as a member name, member age, family members, types of content the member enjoys or dislikes, etc.

The communication style is based on, for example, one or more of a demographic of the one or more other members, an education level of the one or more other members, a culture of the one or more other members, a region of the one or more other members, a specific training of the one or more other members, and/or employment of the one or more other members. The communication style correlates to how the one or more members communicate with other members.

The communication style can be used in generating the optimized communication (106) such that the one or more members would be more open to listening or reading the optimized communication (106) in their own communication style, whereas they may not be open to listening or reading the initial communication (104) that is not in their communication style. For example, an initial communication (104) may include tips for reducing stress stated in a factual style, which may not be readily accepted by other members who prefer to understand why they should reduce their stress. The same members may accept an optimized communication (106) that includes the benefits of reducing stress, why they should reduce stress, and the same tips for reducing stress.

The member information (116) can be received directly from the member or obtained from an account of the member. Alternatively or additionally, the member information (116) can be determined from an analysis of the member's communications (102), the member's account, and/or information provided by the member.

The data repository (100) also stores individual member information (118). The individual member information (118) is the same as the member information (116) for the individual member. For example, the individual member information (118) includes a communication style of the individual member. The individual member information (118)can also include information about the individual member such as the individual member name, individual member age, family members of the individual member, types of content the individual member enjoys or dislikes, etc.

The data repository (100) also stores instructions (120). The instructions (120) include instructions for, for example, a language model such as the language model (138) (described below) to generate the optimized communication (106) using at least the initial communication (104). The instructions (120) can also includes instructions for the language model (138) to generate the optimized communication (106) using the initial communication (104), the member information (116), and/or the individual member information (118). Use of the instructions (120) by the language model (138) is described in FIG. 3.

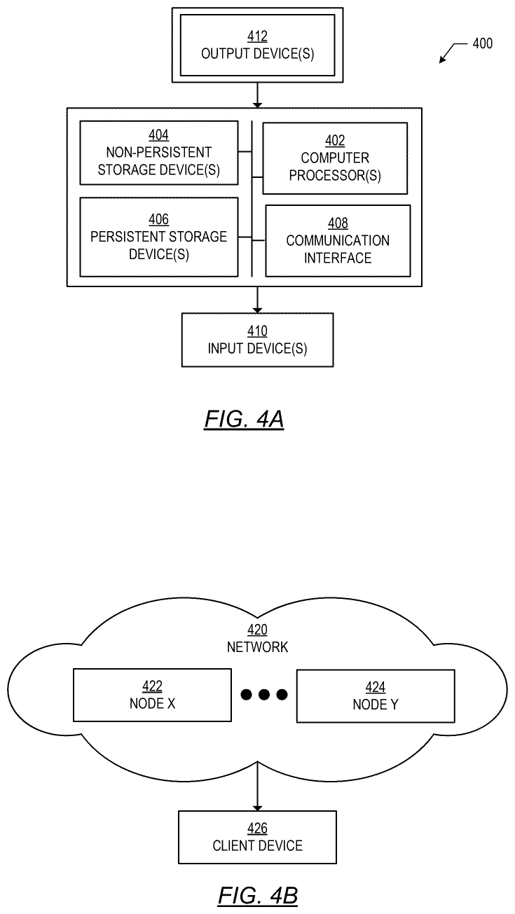

The system shown in FIG. 1 may include other components. For example, the system shown in FIG. 1 also may include a server (130). The server (130) is one or more computer processors, data repositories, communication devices, and supporting hardware and software. The server (130) may be in a distributed computing environment. The server (130) is configured to execute one or more applications, such as a language model (136). An example of a computer system and network that may form the server (130) is described with respect to FIG. 4A and FIG. 4B.

The server (130) also includes a computer processor (132). The computer processor (132) is one or more hardware or virtual processors which may execute computer readable program code that defines one or more applications, such as the language model (136). An example of the computer processor (132) is described with respect to the computer processor(s) (402) of FIG. 4A.

The server (130) also may include a server controller (134). The server controller (134) is software or application specific hardware which, when executed by the computer processor (136), controls and coordinates operation of the software or application specific hardware described herein. Thus, the server controller (134) may control and coordinate execution of the language model (136).

The server (130) also includes a language model (136). The language model (136) is a natural language processing machine learning model. An example of the language model (136) may be a large language model, such as CHATGPT®. However, many different language models may be used. The language model (136) can be used to, for example, convert or “translate” an initial communication (104) into an optimized communication (106). Use of the language model (136) is described with respect to FIG. 3.

The server (130) also includes the communication analyzer (138). The communication analyzer (138) is software or application specific hardware which, when executed by the computer processor (132), analyzes communications (102) to determine the member information (116) and/or the individual member information (118). The communication analyzer (138) which, when executed by the computer processor (132), also analyzes the initial communication (104) to determine the first communication meaning (110).

The server (130) also includes a digital communications network (DCN) (142). The DCN (142) is a network through which members of a population can interact with each other, or with a system supported by the DCN (142). The DCN (142) can also provide means for members of the population to communication with each other. The members of the population can also communication with one or more conversation bots.

In some embodiments the communications between the members of the population on the DCN (142) may be, for example, one to one (e.g., one user to another user), one to many (e.g., one user to many users), one to system (e.g., one user to a system such as, for example, a chatbot), system to many (e.g., a system such as, for example, the chatbot to many users). In some embodiments, the system may be an artificial intelligent bot that derives its communications from an analysis of communications in the DCN (142).

The system shown in FIG. 1 also may include one or more user devices (150). The user devices (150) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (150) are computing systems (e.g., the computing system (400) shown in FIG. 4A) that communicate with the server (130). The user devices (150) may include a wearable monitor (156). In an alternative embodiment, a separate wearable device may be in communication with the user device (150), such as a smart watch, or blood pressure monitor. The user devices (150) may also include a user input device (152) and/or a display device (154). The user devices (150) can be used by the members of the DCN (142) to post communications (102) to the DCN (142) or otherwise communicate with other members of the DCN (142) or with any services supported or provided by the DCN (142).

While FIG. 1 shows a configuration of components, other configurations may be used without departing from the scope of one or more embodiments. For example, various components may be combined to create a single component. As another example, the functionality performed by a single component may be performed by two or more components.

FIG. 2 is a logic flow diagram that illustrates a method, and a result of execution of computer program instructions, in accordance with various embodiments. The method can be used to generate an optimized communication from an initial communication. The method can also, in other instances, be used in part to facilitate or accomplish at least one of: manage the health care cost of the population; reduce the health care risk in the population; and/or slow the progression of an adverse health condition. The adverse health condition can be, for example, chronic systemic inflammation, malaise, low energy, a disease, a health risk, social dysfunction, or a prodromal disease. In embodiments where the adverse health condition is a disease, the disease can be, for example obesity, diabetes, rheumatoid arthritis, Crohn's disease, psoriasis, eczema, cardiovascular disease, congestive heart failure, chronic obstructive pulmonary disease, asthma, depression, or anxiety. In embodiments where the adverse health condition is a health risk, the health risk can be, for example falling or becoming infected with an illness.

At Block 202, a step of providing a digital communication network (DCN) to a population is provided. The DCN may be the same as or similar to the DCN (142). As previously described, members of the population enrolled in the DCN can communicate with each other or with the DCN itself. The members of the population can also communicate with one or more conversation bots.

At Block 204, a step of identifying an individual member is provided. Identifying the individual member may include, for example, identifying the individual member based on one or more communications such as the communications (102) in the DCN. In other instances, identifying the individual member may include receiving an identification of the individual member from, for example, a health care professional team. Identifying the individual member may also include identifying the individual member based on a lifestyle driven disease that the individual member may have or have experience with. The lifestyle driven disease may be, for example, a metabolic disease, an auto-immune disease, or a cardiovascular disease.

At Block 206, a step of receiving an initial communication from the individual member is provided. The initial communication may be the same as or similar to the initial communication (104) and includes a first set of words such as the first set of words (108) and a first communication meaning such as the first communication meaning (110). The initial communication may be a communication that is beneficial to other members of the DCN. For example, the initial communication may include the individual member's experience of improving or alleviating a lifestyle driven disease that the individual member and the other members have. However, the communication style used by the individual member in the initial communication may cause the other members to distrust or ignore the initial communication as currently expressed.

At Block 208, a step of generating an optimized communication based on the initial communication is provided. The optimized communication may be the same as or similar to the optimized communication (106) and includes a second set of words such as the second set of words (112) and a second communication meaning such as the second communication meaning (114). At least one word of the second set of words is different than the first set of words and is optimized for the one or more other members. The second set of words may also be optimized to promote a positive behavior change in the one or more other members, increase happiness in the one or more other members, improve a mood in the one or more other members, to slow a progression of an adverse health condition in the one or more other members, and/or reduce anxiety in the one or more other members.

The second communication meaning in the optimized communication is the same as the first communication meaning such that the optimized communication has the same meaning as the initial communication, but stated differently than the initial communication. In some embodiments, generating the optimized communication uses a language model such as the language model (136) to generate the optimized communication, discussed in detail in FIG. 3.

In other embodiments, the optimized communication may be generated using one or more rules. For example, a rule may be to replace a term used by the individual member (who sent the initial communication) with a term commonly used by the one or more other members (who receive the optimized communication). The one or more rules may be determined by analyzing communications by the one or more other members within the DCN. For example, communications between members of the same age group or range may be analyzed for words or terms commonly used by the age group or range. In other examples, the one or more rules are based on communication styles associated with a demographic, education level, a culture, a region, a specific training, employment, etc.

In still other embodiments, the optimized communication may be generated using other types of artificial intelligence or machine learning models such as conventional neural networks, models that use reinforcement learning, etc.

At Block 210, a step of transmitting the optimized communication to one or more other members is provided. The optimized communication may be transmitted to the one or more other members via the DCN. In some embodiments, the optimized communication is sent directly as a direct message to each member of the one or more other members. In other embodiments, the optimized communication is posted to a forum that the one or more other members are part of.

The method described in FIG. 2 can include more or less steps. One or more steps or any combination of steps may also be repeated in the method described in FIG. 2.

FIG. 3 is a logic flow diagram that illustrates a method, and a result of execution of computer program instructions, in accordance with various embodiments. The method can be used to generate an optimized communication from an initial communication. The method can also, in other instances, be used in part to facilitate or accomplish at least one of: manage the health care cost of the population; reduce the health care risk in the population; and/or slow the progression of an adverse health condition. The adverse health condition can be, for example, chronic systemic inflammation, malaise, low energy, a disease, a health risk, social dysfunction, or a prodromal disease. In embodiments where the adverse health condition is a disease, the disease can be, for example obesity, diabetes, rheumatoid arthritis, Crohn's disease, psoriasis, eczema, cardiovascular disease, congestive heart failure, chronic obstructive pulmonary disease, asthma, depression, or anxiety. In embodiments where the adverse health condition is a health risk, the health risk can be, for example falling or becoming infected with an illness.

At Block 302, a step of providing a digital communication network (DCN) to a population is provided. The Block 302 may be the same as or similar to the Block 202 of FIG. 2 above.

At Block 304, a step of identifying an individual member is provided. The Block 304 may be the same as or similar to the Block 204 of FIG. 2 above.

At Block 306, a step of receiving an initial communication from the individual member is provided. The Block 306 may be the same as or similar to the Block 206 of FIG. 2 above.

At Block 308, a step of prompting a language model with the initial communication, information about one or more other members, and instructions to optimize the initial communication is provided. The language model may be the same as or similar to the language model (136). In some embodiments, the language model is a large language model (LLM).

The information about the one or more other members may be the same as or similar to the member information (116). As previously described, the member information includes a communication style of the one or more other members and can also include information about the one or more other members such as a member name, member age, family members, types of content the member enjoys or dislikes, etc.

The instructions may be the same as or similar to the instructions (120). The instructions prompt the LLM to optimize the initial communication to generate the optimized communication by performing one or more operations, described in Blocks 312 and 314 below.

The instructions include, for example, instructions for the LLM to generate the optimized communication using the initial communication and the member information. More specifically, the instructions may include instructions for the LLM to optimize the initial communication based on the member information. For example, the instructions may include instructions to prompt the LLM to optimize the initial communication to match a communication style of the one or more other members while maintaining the same communication meaning in the optimized communication as the initial communication, as described below.

At Block 310, a step of analyzing a first set of words of the initial communication for a communication meaning is provided. The first set of words may be the same as or similar to the first set of words (108) may be analyzed by the LLM to determine a first communication meaning such as the first communication meaning (110). In some embodiments, individual member information such as the individual member information (118) can also be provided to the LLM to determine the first communication meaning. For example, a communication style of the individual member can be used to determine the first communication meaning. More specifically, the communication style of the individual member may be to provide steps for reducing stress that have worked for the individual member, but does not provide why the steps for reducing stress are beneficial or why they reduce stress. Such communication style can be used to determine that the first communication meaning is that reducing stress is beneficial to the individual member.

At Block 312, determining a second set of words defining an optimized communication based on the first communication meaning and the information about the one or more other members is provided. The second set of words may be the same as or similar to the second set of words (112) and have a second communication meaning such as the second communication meaning (114). The second set of words may be generated by the LLM using the instructions to optimize the first set of words based on at least the communication style of the one or more other members while maintaining the first communication meaning. For example, the communication style of the one or more other members may correlate to the one or more other members wanting to understand why an action works or should be taken. In such example, the second set of words may include the steps for reducing stress and may also include reasons for why the steps work to reduce stress and the benefits of such steps. Thus, the second set of words are worded to include the reasons for why the steps work and the benefits in line with the communication style of the one or more other members while also maintaining the same communication meaning of steps for reducing stress.

At Block 314, a step of transmitting the optimized communication to one or more other members is provided. The Block 314 may be the same as or similar to the Block 210 of FIG. 2 above.

The method described in FIG. 3 can include more or less steps. One or more steps or any combination of steps may also be repeated in the method described in FIG. 3.

The methods of FIGS. 2 and 3 described above beneficially provide for generating optimized communications based on initial communications while maintaining the same communication meaning. Such methods can be used to optimize communications from an individual member for a target set of members that would otherwise not value or trust communications from the individual member. For example, communications from an individual member that include beneficial actions the individual member has taken to improve their lives in the communication style of the individual member may not be trusted or valued by the target set of members. However, communications optimized for the target set of members in their own communication style that include the same beneficial actions may be trusted and valued by the target set of members. Such optimized communications may encourage the target set of members to try or adopt actions suggested by the optimized communications that the target set of members may not have otherwise valued or trusted. Thus, the target set of members may try actions that improve their own lives that they otherwise may not have tried before.

The optimized communication may also be directed to several other benefits. For example, the optimized communication may be directed to achieving a positive behavior change in the members receiving the optimized communication. In another example, the optimized communication may be directed to optimizing a wellbeing of the members receiving the optimized communication such as increasing happiness, improving a mood, and/or reducing anxiety.

The optimized communication may be used in a method to slow the progression of adverse health conditions in an individual member of the population. In such examples the condition may be, for example, a disease such as obesity, diabetes, Crohn's, psoriasis, eczema, asthma, depression, anxiety, rheumatoid arthritis, cardiovascular disease, congestive heart failure, and chronic obstructive pulmonary disease. In other examples, the condition may be a health risk such as, for example, falling, contracting an illness, etc. In still other examples, the condition may be a social dysfunction or a prodromal disease.

The optimized communication may be used to slow the progression of adverse health conditions in the individual member by connecting the individual member with other members of the population with the same or similar health conditions. Such communications can be used by the individual member to improve their health or help the individual member cope with their adverse health conditions. More specifically, the information in the optimized communication may be helpful to the individual member and thus, the more receptive the individual member is to the optimized communication the higher likelihood the individual member will use the information in the optimized communication.

The optimized communication may also be used in a method to improve communication on the DCN. For example, in general, members of experiencing similar health conditions may benefit from communicating with each other and forming a community. The optimized communication may help prevent members from being biased against each other in their communications.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method for generating an optimized communication, the method comprising:
providing a digital communication network (DCN) for a plurality of members of a population to communicate with each other;
identifying an individual member of the plurality of members;
receiving an initial communication from the individual member on the DCN, the initial communication having a first set of words;
generating an optimized communication based on the initial communication, the optimized communication having a second set of words, wherein at least one word of the second set of words is different from the first set of words, wherein the second set of words are optimized for one or more other members of the plurality of members, and wherein the second set of words has a second communication meaning that is the same as a first communication meaning of the first set of words;
transmitting the optimized communication to the one or more other members of the plurality of members.

2. The method of claim 1, wherein generating the optimized communication includes prompting a large language model with the initial communication, information about the one or more other members, and instructions to optimize the initial communication for the one or more members while keeping the same communication meaning.

3. The method of claim 2, wherein the language model optimizes the initial communications by performing the operations of:
analyzing the first set of words for the communication meaning; and
determining the second set of words based on the communication meaning and the information about the one or more other members.

4. The method of claim 3, wherein the information about the one or more other members includes a communication style of the one or more other members.

5. The method of claim 4, wherein the communication style is based on one or more of a demographic of the one or more other members, an education level of the one or more other members, a culture of the one or more other members, a region of the one or more other members, a specific training of the one or more other members, or employment of the one or more other members.

6. The method of claim 1, wherein the second set of words is further optimized to at least one or more of promote a positive behavior change in the one or more other members, increase happiness in the one or more other members, improve a mood in the one or more other members, or reduce anxiety in the one or more other members.

7. The method of claim 1, wherein the second set of words is further optimized to slow a progression of an adverse health condition in the one or more other members.

8. The method of claim 7, wherein the adverse condition is determined by automatically analyzing communications from the one or more other members.

9. The method of claim 7, wherein the adverse health condition comprises at least one of chronic systemic inflammation, malaise, low energy, a disease, a health risk, social dysfunction, or a prodromal disease.

10. The method of claim 9, wherein the disease comprises at least one of obesity, diabetes, rheumatoid arthritis, Crohn's disease, psoriasis, eczema, cardiovascular disease, congestive heart failure, chronic obstructive pulmonary disease, asthma, depression, or anxiety.

11. The method of claim 9, wherein the health risk is at least one of falling or becoming infected with an illness.

12. A system for generating an optimized communication, the system comprising:
a computer processor;
a data repository in communication with the computer processor and storing:
an initial communication having a first set of words and a first communication meaning, and
an optimized communication having a second set of words and a second communication meaning;
a digital communications network (DCN) which, when executed by the computer processor, provides a network for a plurality of members of a population to interact with at least each other or the DCN; and
a server controller which, when executed by the computer processor:
receives the initial communication from the individual member;
generates an optimized communication based on the initial communication;
transmits the optimized communication to one or more other members of the plurality of members,
wherein at least one word of the second set of words is different from the first set of words,
wherein the second set of words are optimized for one or more other members of the plurality of members, and
wherein the second set of words has a second communication meaning that is the same as a first communication meaning of the first set of words.

13. The system of claim 12, wherein generating the optimized communication includes prompting a large language model with the initial communication, information about the one or more other members, and instructions to optimize the initial communication for the one or more members while keeping the same communication meaning.

14. The system of claim 13, wherein the language model optimizes the initial communications by performing the operations of:
analyzing the first set of words for the communication meaning; and
determining the second set of words based on the communication meaning and the information about the one or more other members.

15. The system of claim 14, wherein the information about the one or more other members includes a communication style of the one or more other members.

16. The system of claim 15, wherein the communication style is based on one or more of a demographic of the one or more other members, an education level of the one or more other members, a culture of the one or more other members, a region of the one or more other members, a specific training of the one or more other members, or employment of the one or more other members.

17. The system of claim 12, wherein the second set of words is further optimized to at least one or more of promote a positive behavior change in the one or more other members, increase happiness in the one or more other members, improve a mood in the one or more other members, or reduce anxiety in the one or more other members.

18. The system of claim 12, wherein the second set of words is further optimized to slow a progression of an adverse health condition in the one or more other members.

19. The system of claim 12, wherein the adverse condition is determined by automatically analyzing communications from the one or more other members.

20. The system of claim 19, wherein the adverse health condition comprises at least one of chronic systemic inflammation, malaise, low energy, a disease, a health risk, social dysfunction, or a prodromal disease.
